(19) United States
(12) Patent Application Publication
(10) Pub. No.: US 2003/0120927 A1
(43) Pub. Date: Jun. 26, 2003

(54) Apparatus and method for providing digital contents by using watermarking technique

(76) Inventors: Wook Joong Kim, Taejon (KR); Jong Won Seok, Taejon (KR); Jin Woo Hong, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 10/125,521

(22) Filed: Apr. 19, 2002

(30) Foreign Application Priority Data
Dec. 24, 2001 (KR) 2001-84486

(51) Int. Cl. H04L 9/00

(52) U.S. Cl. 713/176

(57) ABSTRACT

A digital content distributor provides a way to prevent digital content from being used by unauthorized users by transforming digital content based on transform information and embedding the transform information and watermark signal into the digital content when the digital content is distributed through a communication network. The digital content distributor includes a signal transforming unit, a watermark embedding unit, a watermark extracting unit and the inverse-transforming unit. At a distributing end, the signal transforming unit transforms a digital content signal by using the transform information and the watermark embedding unit embeds the transform information and the watermark signal into the transformed digital content signal. At a receiving end, the watermark extracting unit extracts the watermark signal and the transform information from the received digital content signal and the inverse-transforming unit restores the digital content signal by inverse-transforming the received digital content signal by using the extracted transform information.

### FIELD OF THE INVENTION

The present invention relates to an apparatus and method for distributing digital contents by using watermarking; and more particularly, to an apparatus and method for distributing digital contents by embedding a watermark signal and transform information into an original digital content for protecting a copyright of the digital content and preventing the digital content itself from being used by an unauthorized person with impure purpose.

### DESCRIPTION OF RELATED ARTS

The development of the Internet, higher bandwidth and quality of service for both wired and wireless networks has made it possible to create, replicate, transmit, and distribute digital content in an effortless way. However, digitalized multimedia files including an MP3 music file or a movie file is easily replicated and distributed illegally by unauthorized persons. As a result, the protection and enforcement of intellectual property rights for digital content has become an important issue.

One of widely used methods for protecting digital content from an unauthorized usage is a data encryption. The digital content protected by the data encryption does not allow to be accessed without a predefined encryption method. However, after it has been decoded, the digital content is easily replicated and distributed.

To overcome the above problems, there has been introduced a watermarking technique which is a method for protecting digital contents from the unauthorized usage by embedding a watermarking signal as a kind of digital signature into an original digital content and detecting the watermarking signal from the watermarked digital content.

Generally, the watermarking technique has been used for protecting a copyright and tracing an unauthorized replication and distribution. For protecting the copyright, the digital signature is embedded into the original digital content in the form of the watermarking signal so as to prepare for a dispute for the copyright of the digital content. Then, by extracting the embedded digital signature, e.g., the watermarking signal, from the watermarked digital content, the copyright of the digital content can be authenticated. The watermarking technique also can trace the unauthorized replication and distribution of the digital content by embedding different watermarking signals into the original digital content according to distribution steps, so that it is possible to ascertain a distribution channel of illegally distributed digital content.

Implementing the watermarking technique into multimedia contents such as digital images, video and audio has some requirements such as imperceptibility, robustness and perspicuity. The watermark signal embedded into digital contents has to be unrecognizable visually and audibly. That is, a quality of digital content should not be deteriorated by the embedded watermark signal and even if it deteriorates the quality of digital content, it must be imperceptible. The watermark signal also has to be robust from unauthorized access. Namely, the watermark signal must not be damaged, altered or deleted during various digital processes or by attacking of an unauthorized person with an impure purpose. Finally, the watermark signal has to be perspicuous. The watermark signal needs to be clear to show its ownership. That is, the embedded watermark signal must not be misrecognized as other's watermark signal and, if there is no embedded watermark signal in digital content, no watermark signal should be detected from the digital content.

FIG. 1 is a schematic diagram illustrating an example of watermark embedding and detection/decoding applied to digital content.

A watermark inserter 110 embeds a watermark signal 102 into an original digital signal 101. Due to the imperceptibility of the watermark, a watermark embedded signal 103 does not have any difference visually and audibly compared to the original digital signal. A watermark detector 120 detects the embedded watermark signal from the watermark embedded signal 103 to thereby output a detected watermark signal 104 which is identical with the watermark signal 102.

The watermark detector 120 only detects the watermark signal embedded in the watermark embedded signal 103. Therefore, the watermark signal is not deleted through the watermark detecting process.

FIG. 2 shows a schematic diagram of a digital content distributing apparatus by using a conventional watermarking technique.

A copyright holder embeds a watermark signal showing a copyright ownership of digital content into an original digital content signal by using a watermark inserter 201 so as to prepare for a dispute related to the copyright of the digital content, which may happen in future. A digital content distributor 202 distributes the watermark embedded digital content signal through a communication network 203 including, e.g., the Internet. The distributed digital content signal is received by a digital content receiver 204. If necessary, a watermark detector 205 detects the watermark signal from the received digital content signal.

Since, however the above-mentioned digital content distributing apparatus protects the copyright of the digital content by employing the conventional watermarking technique, it is only used in authenticating the copyright ownership in the copyright dispute instead of providing a way of precluding the digital content from being used by unauthorized users with an impure purpose such as illegal replication, illegal distribution, or illegal modification. That is, the watermarking technique cannot constrain the illegal usage of the digital content in a positive light like the encryption method.

Additionally, due to the imperceptibility of the watermark signal, the watermark embedded digital content is also easily distributed by the unauthorized users.

### SUMMARY OF THE INVENTION

It is, therefore, an object of the present invention to provide an apparatus and method for distributing digital contents by transforming original digital content according to predefined transform information and embedding the transform information into the original digital content by a watermarking technique. In other words, the present invention provides a function of protecting digital content from an illegal usage with the copyright protection function.

In accordance with an aspect of the present invention, there is provided an apparatus for providing an apparatus for distributing digital content by using a watermarking technique, including: a signal transforming unit for transforming an original digital content signal by using transform information; and a watermark embedding unit for embedding the transform information and a watermark signal into the transformed digital content signal generated from the signal transforming unit.

In accordance with another aspect of the present invention, there is also provided an apparatus for distributing a digital content by using a watermarking technique, further including a transmitting unit for transmitting the transformed and watermark embedded digital content signal generated from the watermark embedding unit through a communication network.

In accordance with another aspect of the present invention, there is also provided an apparatus for distributing digital content by using a watermark technique, including: a watermark extracting unit for extracting a watermark signal and transform information from a transformed and watermark embedded digital content signal; and an inverse-transforming unit for generating a watermark embedded digital content signal by inverse-transforming the transformed and watermark embedded digital content signal by using the extracted transform information.

In accordance with another aspect of the present invention, there is also provided an apparatus for distributing digital content by using a watermark technique further including a receiving unit for receiving the transformed and watermark embedded and transformed digital content signal through a communication network.

In accordance with another aspect of the present invention, there is also provided a method for distributing digital content by using a watermark technique, including the steps of: a) transforming an original digital content signal by using transform information; and b) generating a transformed and watermark embedded digital content signal by embedding the transform information and a watermark signal into the transformed digital content signal from the step a).

In accordance with another aspect of the present invention, there is also provided the method for distributing digital content by using a watermark technique further including the step of transmitting the transformed and watermark embedded digital content signal through a communication network.

In accordance with another aspect of the present invention, there is also provided a method for distributing digital content by using a watermark technique, including the steps of: a) extracting a watermark signal and transform information from a transformed and watermark embedded digital content signal; and b) inverse-transforming the transformed and watermark embedded digital content signal by using the extracted transform information to thereby output a watermark embedded digital content signal.

In accordance with another aspect of the present invention, there is also provided the method further including the step of receiving the transformed and watermark embedded digital content signal through a communication network before the step a).

### BRIEF DESCRIPTION OF THE DRAWINGS

The above and other objects and features of the present invention will become apparent from the following description of the preferred embodiments given in conjunction with the accompanying drawings, in which:

FIG. 1 is a schematic diagram illustrating an example of watermark embedding and detection/decoding applied to digital content;

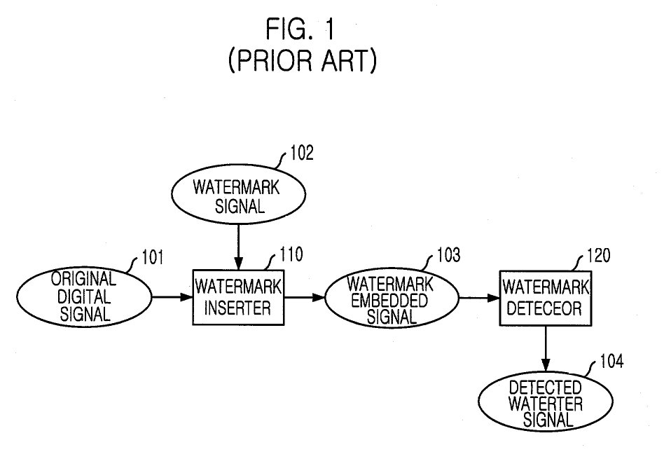

FIG. 2 shows a schematic diagram of a digital content distributing apparatus by using a conventional watermarking technique;

FIG. 3 provides a schematic diagram of a digital content distributing apparatus by using a watermarking technique in accordance with the present invention; and

FIG. 4 is a flowchart illustrating a method for distributing digital content by using a watermarking technique in accordance with the present invention.

### DETAILED DESCRIPTION OF THE INVENTION

Other objects and aspects of the invention will become apparent from the following description of the embodiments with reference to the accompanying drawings, which is set forth hereinafter.

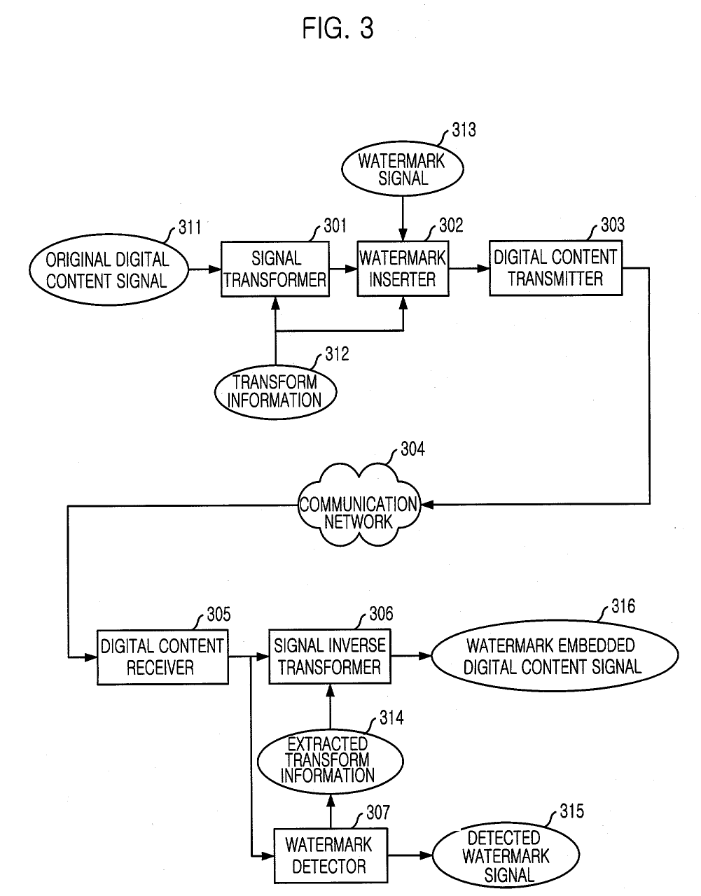

FIG. 3 illustrates a schematic diagram of a digital content distributing apparatus in accordance with a preferred embodiment of the present invention.

Referring to FIG. 3, an example of providing digital content through a communication network is explained in detail. The present invention can be implemented to provide the digital content by using not only the communication network but also a computer readable recording medium.

At first, an original digital content signal 311 is inputted to a signal transformer 301, which transforms the original digital content signal 311 based on transform information 312. Various transform techniques can be used for transforming the original digital content signal such as adding/subtracting a predefined value to/from the original digital content signal or converting the original digital content signal by using a specific function or by performing an exclusive OR (XOR) operation. The transform techniques may be implemented in a certain part of the digital content or in the entire digital content. For example, if the original digital content is an image, transformed digital content may contain some specific letters or changed color, or the locations of some blocks of the image can be changed. If the original digital content is audio, the transformed digital content may contain specific noises.

The transform information is expressed in a certain length of binary numbers.

The signal transformer 301 also needs to be equipped with an inverse transform or pseudo-inverse transform function for the transformed digital content signal. That is, in case the original digital content signal 311 is transformed based on the transform information 312, the transformed digital content signal should be perfectly restored, i.e., inverse-transformed, by using the transform information 312 or the difference between the inverse-transformed digital content signal and the original digital content signal 311 must be imperceptible visually and audibly.

Then, the transformed digital content signal is transmitted to a watermark inserter 302 which, in turn, embeds the transform information 312 and a watermark signal 313 such as information for a copyright holder in the transformed digital content signal.

The transformed and watermark embedded digital content signal is transmitted through a digital content transmitter 303 and a communication network 304.

At a receiving end, a digital content receiver 305 receives the transmitted digital content signal.

Since the received digital content signal has a difference compared to the original digital content signal 311, in case that the receiving end does not have an authorization for the usage of the digital content, the receiving end cannot extract the embedded transform information from the received digital content signal, cannot interpret the extracted transform information 314 even if the embedded transform information is extracted, or cannot inverse-transform the received digital content signal to the original digital content signal without the specific inverse transform apparatus even if the extracted transform information 314 is interpreted. That is, a user at the receiving end cannot utilize the original digital content signal without the authorization for the usage of the digital content.

On the other hand, in case of the user having the authorization for the usage of the digital content, at the receiving end, a watermark detector 307 extracts a detected watermark signal 315 and the extracted transform information 314 from the received digital content signal. A signal inverse transformer 306 analyzes the extracted transform information 314 and inverse-transforms the received digital content signal to thereby provide a watermark embedded digital content signal 316 which has no difference or an imperceptible difference compared to the original digital content signal.

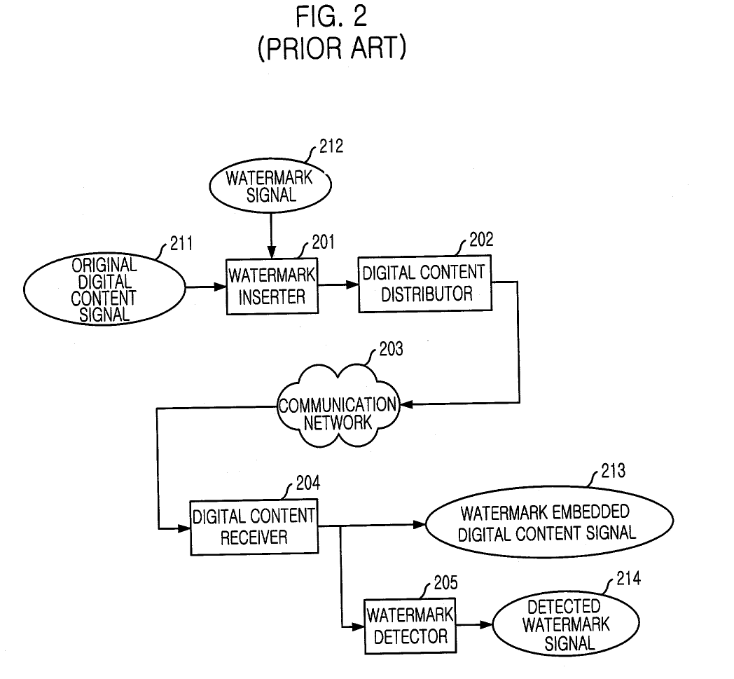

The conventional digital content distributing apparatus using the watermarking technique in FIG. 2 cannot prevent the digital content from being used by an unauthorized user, whereas the present invention in FIG. 3 can preclude the digital content from being used by the unauthorized user who does not know an inverse transform method by additionally inserting the transform information 312 into the digital content by using the watermarking. Like the conventional apparatus in FIG. 2, the present invention in FIG. 3 also allows the watermark signal such as the information for the copyright holder to remain in the digital content to be utilized by users and, therefore, the present invention can prepare for a future possible dispute for the copyright ownership.

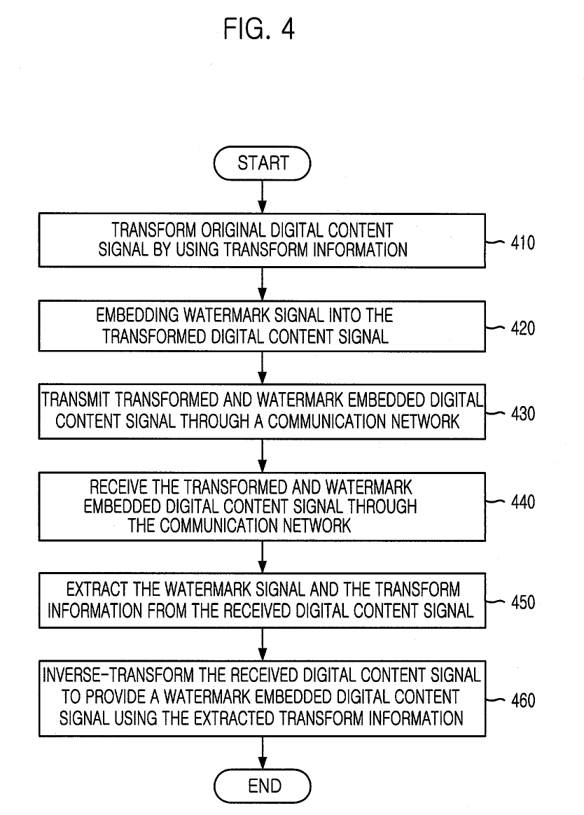

FIG. 4 is a flowchart illustrating a method for distributing digital contents by using a watermarking technique in accordance with the present invention.

Referring to FIG. 4, the method for distributing digital content by using the watermarking technique in accordance with the present invention is explained in detail hereinafter.

At first, an original digital content signal is transformed by using transform information at step 410 for preventing the digital content from being utilized by unauthorized users. Various transform techniques can be employed for transforming the original digital content signal such as adding/subtracting a predefined value to/from the original digital content signal or converting the original digital content signal by using a specific function or by performing an exclusive OR (XOR) operation. The transform techniques may be implemented in a certain part of the digital content or in the entire digital content. For example, if the original digital content contains an image of human, the transform process may be performed only for the part of the image of the human in the original digital content.

The transform information is expressed in a certain length of binary numbers.

After transforming the original digital content signal, a watermark signal is embedded into the transformed digital content signal at step 420. At step 420, the transform information is also embedded into the transformed digital content signal with the watermark signal to thereby produce transformed and watermark embedded digital content signal.

The transformed and watermark embedded digital content signal is transmitted through a communication network at step 430.

If the transformed and watermark embedded digital content signal is received through the communication network at step 440, the watermark signal and the transform information are extracted from the received digital content signal at step 450. The extracted transform information is used for inverse-transforming the received digital content signal and the extracted watermark signal is used for verifying information for the digital content.

By using the extracted transform information, the received digital content signal is inverse-transformed to provide a watermark embedded digital content signal at step 460. The inverse-transformed digital content signal may have no difference compared with the original digital content signal or may have imperceptible difference, which is not recognizable visually and audibly by the users.

Since a copyright holders have demand to protect the copyright of the digital content in distribution and usage of the digital content, and the demands of copyright holder can be satisfied by using the above-mentioned present invention.

Also, the present invention cab lead a lawful usage of the digital content and provide a proper reward to the copyright holder of the digital content. Therefore, it finally leads to develop techniques for creation, distribution and usage of the digital content.

While the present invention has been described with respect to certain preferred embodiments, it will be apparent to those skilled in the art that various changes and modifications may be made without departing from the scope of the invention as defined in the following claims.

What is claimed is:

1. An apparatus for distributing digital content by using a watermarking technique, comprising:
a signal transforming means for transforming an original digital content signal by using transform information; and
a watermark embedding means for embedding the transform information and a watermark signal into the transformed digital content signal generated from the signal transforming means.

2. The apparatus as recited in claim 1, further comprising a transmitting means for transmitting the transformed and watermark embedded digital content signal generated from the watermark embedding means through a communication network.

3. The apparatus as recited in claim 1, wherein the transform information is expressed in a certain length of binary numbers.

4. The apparatus as recited in claim 1, wherein the signal transforming means converts the original digital content signal to the transformed digital content signal, which could be perfectly restored by authorized users performing an inverse-transform process.

5. The apparatus in recited as claim 1, wherein the signal transforming means produces the transformed digital content signal, which has an imperceptible difference compared to the original digital content signal after inverse-transformed by authorized users.

6. An apparatus for distributing digital content by using a watermark technique, comprising:
a watermark extracting means for extracting a watermark signal and transform information from a transformed and watermark embedded digital content signal; and
an inverse-transforming means for generating a watermark embedded digital content signal by inverse-transforming the transformed and watermark embedded digital content signal by using the extracted transform information.

7. The apparatus as recited in claim 6, further comprising a receiving means for receiving the transformed and watermark embedded and transformed digital content signal through a communication network.

8. The apparatus as recited in claim 6, wherein the transform information is expressed in a certain length of binary numbers.

9. A method for distributing digital content by using a watermark technique, comprising the steps of:
a) transforming an original digital content signal by using transform information; and
b) generating a transformed and watermark embedded digital content signal by embedding the transform information and a watermark signal into the transformed digital content signal from the step a).

10. The method as recited in claim 9, further comprising the step of transmitting the transformed and watermark embedded digital content signal through a communication network.

11. The method as recited in claim 9, wherein the transform information is expressed in a certain length of binary numbers.

12. The method as recited in claim 9, wherein, in the step a), the original digital content signal is transformed to the transformed digital content signal, which could be perfectly restored by authorized users performing an inverse-transform process.

13. The method as recited in claim 9, wherein, in the step a), the original digital content signal is transformed to provide the transformed digital content signal, which has an imperceptible difference compared to the original digital content signal after inverse-transformed by authorized users.

14. A method for distributing digital content by using a watermark technique, comprising the steps of:
a) extracting a watermark signal and transform information from a transformed and watermark embedded digital content signal; and
b) inverse-transforming the transformed and watermark embedded digital content signal by using the extracted transform information to thereby output a watermark embedded digital content signal

15. The method as recited in claim 14, further comprising the step of receiving the transformed and watermark embedded digital content signal through a communication network before the step a).

16. The method as recited in claim 14, wherein the transform information is expressed in a certain length of binary numbers.
